(19) United States
(12) Patent Application Publication
(10) Pub. No.: US 2013/0183162 A1
(43) Pub. Date: Jul. 18, 2013

(54) NACELLE FOR WIND TURBINE

(71) Applicant: Kristina Anne Cruden, Greenville, SC (US)

(72) Inventor: Kristina Anne Cruden, Greenville, SC (US)

(73) Assignee: GENERAL ELECTRIC COMPANY, Schenectady, NY (US)

(21) Appl. No.: 13/351,529

(22) Filed: Jan. 17, 2012

(51) Int. Cl. F03D 11/04; F03D 1/00

(52) U.S. Cl. 416/244 R

(57) ABSTRACT

A nacelle for a wind turbine is disclosed. The nacelle includes a base platform, a frame, and a flexible membrane. The frame includes a plurality of beams and defines an interior. The flexible membrane is connected to the frame and further defines the interior. The flexible membrane includes a polymer material. The interior is substantially enclosed.

### FIELD OF THE INVENTION

The present disclosure relates in general to wind turbines, and more particularly to nacelles for wind turbines.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

Various components of a wind turbine are typically housed within the nacelle. For example, the rotor hub, which connects to the rotor blades, is further generally coupled to a shaft. The shaft may extend into the nacelle. A gearbox and generator coupled to the shaft may be housed within the nacelle.

Nacelles are typically constructed from a rigid fiberglass material. Sections of the fiberglass material are bolted together to form a shell defining an interior volume. This shell houses various components therein and forms the outer housing of the nacelle. However, such nacelle construction has a variety of disadvantages. For example, rigid fiberglass sections formed on the scale of wind turbine nacelles are relatively heavy. Further, the increased size of wind turbines necessitates increases in the size of these sections. These size and weight limitations make transportation of the nacelle sections to wind turbine locations, and construction of the wind turbines at those locations, increasingly difficult. Further, after construction of a wind turbine, access to the interior of the nacelle may be relatively limited due to the use of rigid fiberglass materials. For example, access may be limited to doors built into the fiberglass materials. Thus, if components within the nacelle become damaged and require replacement, it may be difficult to remove these components and introduce new components into the nacelle. For example, sections of the nacelle may have to be removed to facilitate removal of components, which can be a costly, time consuming process.

Accordingly, an improved wind turbine and nacelle for a wind turbine would be advantageous. For example, a nacelle formed from a material that is relatively easily manipulated and transportable, and that is relatively inexpensive and lightweight, would be desired.

### BRIEF DESCRIPTION OF THE INVENTION

Aspects and advantages of the invention will be set forth in part in the following description, or may be obvious from the description, or may be learned through practice of the invention.

In one embodiment, a nacelle for a wind turbine is disclosed. The nacelle includes a base platform, a frame, and a flexible membrane. The frame includes a plurality of beams and defines an interior. The flexible membrane is connected to the frame and further defines the interior. The flexible membrane includes a polymer material. The interior is substantially enclosed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a nacelle according to the present disclosure;

FIG. 3 illustrates a cross-sectional view of one embodiment of a portion of a nacelle according to the present disclosure; and,

FIG. 4 illustrates a front view of one embodiment of an access passage of a nacelle partially covered by a passage cover portion of the nacelle according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

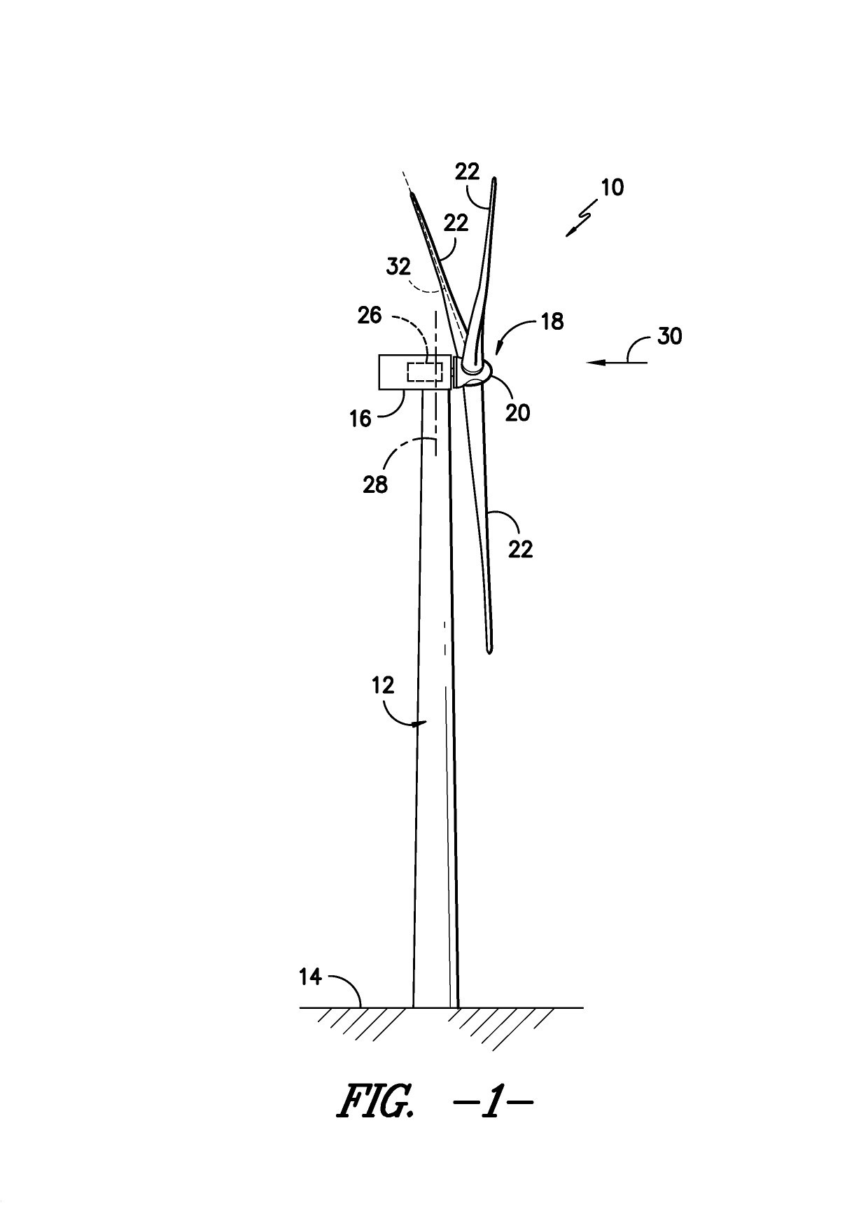

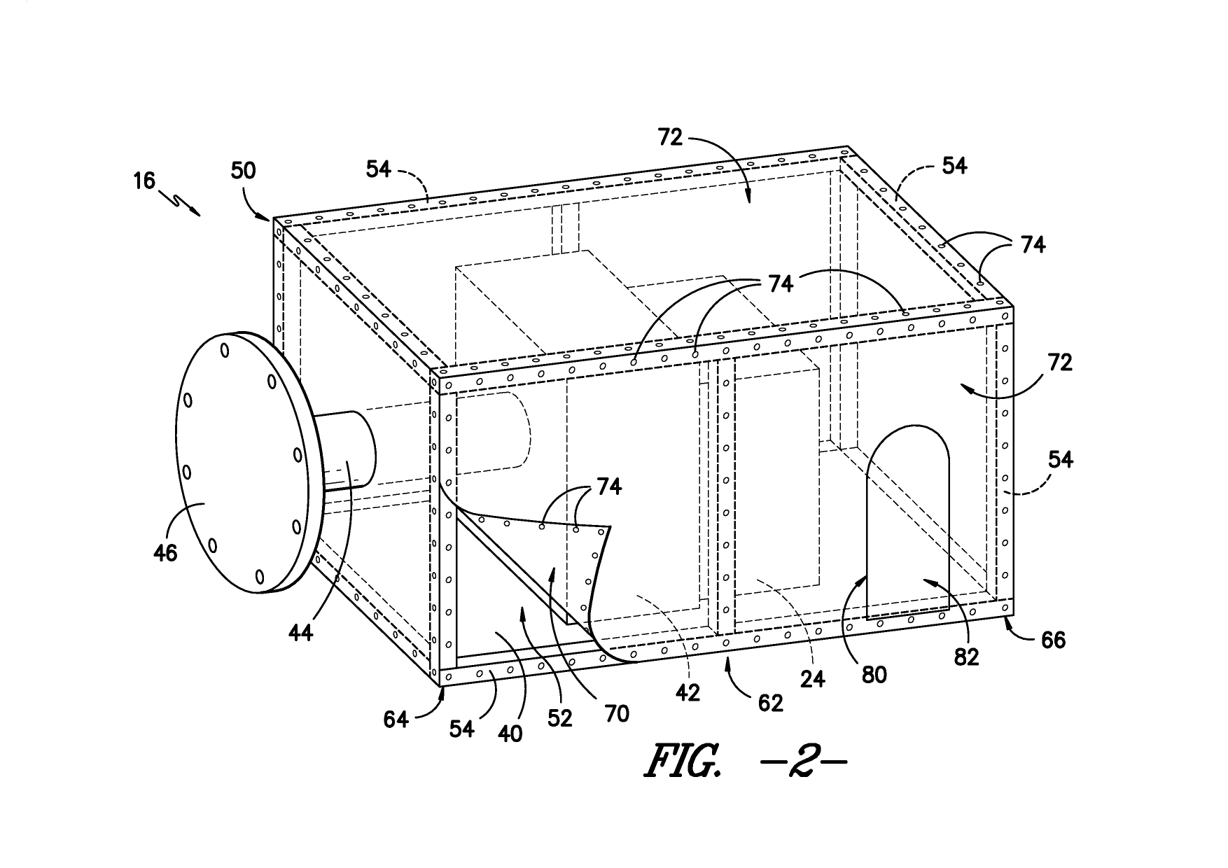

Referring to the drawings, FIG. 1 illustrates a perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally include any suitable processing unit configured to perform the functions described herein. Thus, in several embodiments, the turbine controller 26 may include suitable computer-readable instructions that, when implemented, configure the controller 26 perform various different actions, such as transmitting and executing wind turbine control signals, receiving and analyzing sensor signals and generating message signals to provide an indication of the wear occurring on any brake pads of the wind turbine 10.

By transmitting and executing wind turbine control signals, the turbine controller 26 may generally be configured to control the various operating modes (e.g., start-up or shut-down sequences) and/or components of the wind turbine 10. For example, the controller 26 may be configured to control the yaw direction of the nacelle 16 about a yaw axis 28 to position the rotor blades 22 with respect to the direction 30 of the wind, thereby controlling the load and power output generated by the wind turbine 10. Additionally, the controller 26 may be configured to control the pitch of the rotor blades 22 about individual pitch axes 32 with respect to the direction 30 of the wind, thereby further controlling the load and power output generated by the wind turbine 10.

Referring now to FIG. 2, a nacelle 16 of a wind turbine 10 according to the present disclosure is shown. The nacelle 16 includes a base platform 40, also know as a bed plate. The base platform 40 supports various internal components of the nacelle 16 thereon. For example, the base platform 40 may support the generator 24, and may further support a gearbox 42. The gearbox 42 may be configured between the generator 24 and a rotor shaft 44 to modify input rotational characteristics of the shaft 44 and supply an output rotation to the generator 24. Alternatively, the shaft 44 may be directly connected to the generator 24. The shaft 44 may extend from the generator 24 or gearbox 42 to the rotor 18. For example, a hub flange 46 disposed on an end of the shaft 44 may be configured for connection to the hub 20. Rotation of the rotor blades 22 rotates the shaft 44, and this rotation is supplied to the generator 24.

The base platform 40 may additionally support any other suitable internal components of the nacelle 16, such as brakes (not shown), heat exchangers (not shown), controllers 26, etc., thereon.

A nacelle 16 according to the present disclosure may further include a frame 50. The frame 50 may generally define an interior 52 of the nacelle 16. For example, as shown, the frame 50 may provide a skeleton that defines at least a portion of the outer perimeter of the nacelle 16, and thus further defines the interior 52 of the nacelle 16 therein. Internal components of the nacelle 16 may thus generally be contained within the interior 52 defined by the frame 50.

The frame 50 may include a plurality of beams 54. The beams 54 may be arranged to define the outer perimeter of the nacelle 16, and may thus be joined to each other at various locations along the beams 54. For example, each beam 54 may include a body 62 extending between a first end 64 and a second end 66. A beam 54 may be connected to another beam 54 at its first end 64 or second end 66, or at any other suitable intermediate location along the body 62. The beams 54 may be joined using any suitable joining technique or apparatus. For example, beams 54 may be welded together, or may be joined together using suitable mechanical fasteners, such as nut-bolt combinations, rivets, screws, nails, etc. The frame 50 formed by the beams 54 may have any suitable shape and/or size. For example, the frame 50 may be generally cubic or cuboid shaped, or generally conical, spherical, or cylindrical, or may have any other suitable shape.

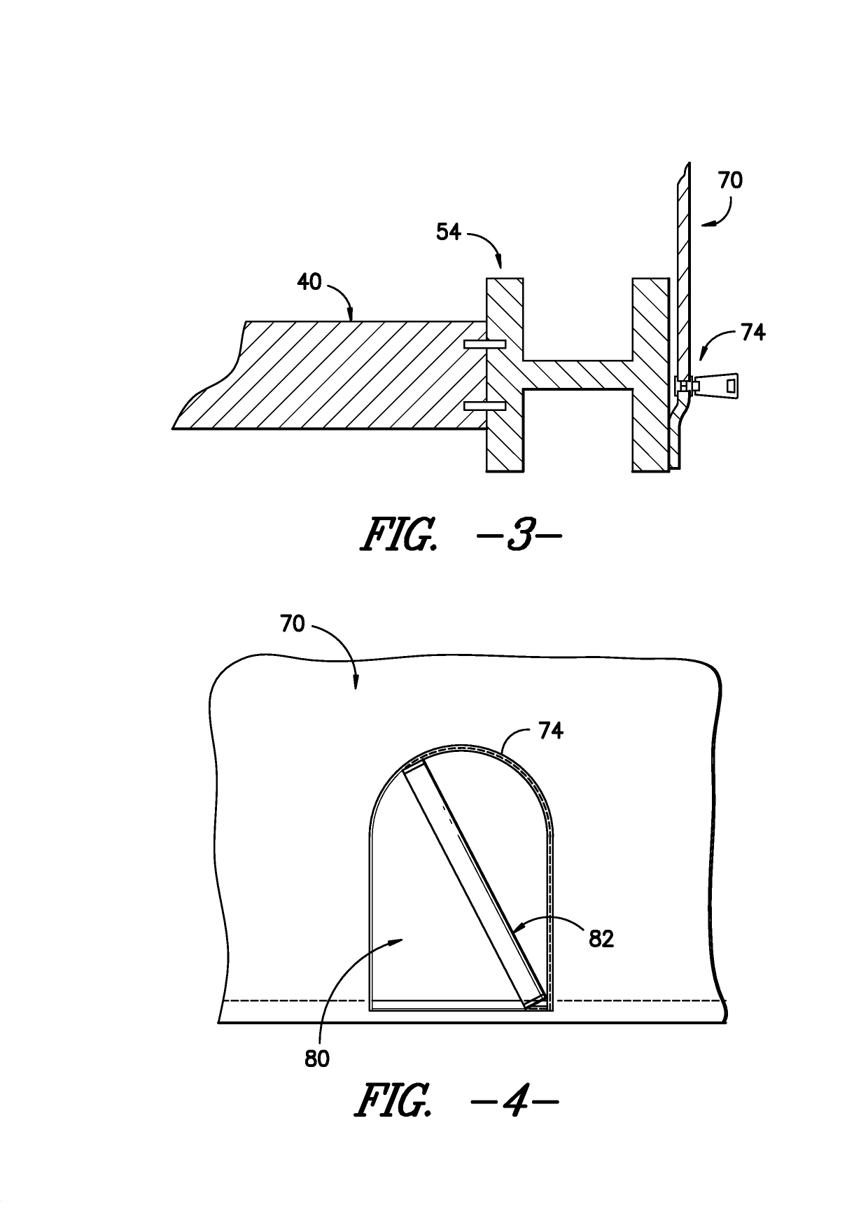

Additionally, in some embodiments as shown in FIGS. 2 and 3, one or more beams 54 may be joined to the base platform 40. For example, beams 54 may be joined to the base platform 40 about the perimeter of the base platform 40, thus at least partially surrounding the base platform 40.

In exemplary embodiments as shown in FIG. 3, one or more of the beams 54 are I-beams. An I-beam may, for example, have a generally I or H shaped cross-sectional profile. Alternatively, a suitable beam 54 according to the present disclosure may be a Z-beam having a generally Z shaped cross-sectional profile; a T-beam having a generally T shaped cross-sectional profile; a channel beam having a cross-sectional profile that defines a channel therein; an L-beam having a generally L shaped cross-sectional profile; a hollow structural section beam having for example a square, rectangular, circular, oval or otherwise cross-sectional profile; a solid structural section having for example a square, rectangular, circular, oval or otherwise cross-sectional profile; a plate; a joist; or any other suitable structural member.

A nacelle according to the present disclosure may further include a flexible membrane 70. The flexible membrane 70 further defines the interior 52, and at least partially encloses the interior 52. The flexible membrane 70 is connected to the frame 50, such as to the beams 54 thereof. Further, the flexible membrane 70 may extend between several of the beams 54 to enclose the interior 52.

A flexible membrane 70 according to the present disclosure may be formed from a suitable polymer material. The material forming the membrane 70 allows the membrane 70 to be flexible. Flexible means that the membrane 70 can be bent, folded and/or rolled up as desired, without cracking or breaking. The use of a flexible material to form the membrane 70 provides advantageous cost, transportation, and construction benefits. For example, a membrane 70 according to the present disclosure can be folded or rolled up for transportation to a wind turbine 10 construction site. Transportation difficulties associated with previously known stiff, large fiberglass nacelle sections are thus eliminated. Transportation of the membrane 70 is thus easier and more cost effective. Further, construction difficulties associated with previously known stiff, large fiberglass nacelle sections are eliminated. For example, the membrane 70 can be hoisted by a crane during construction in a rolled up position, and can then be unrolled over the frame 50. Still further, difficulties during repair and/or replacement of components internal to the nacelle 16 are eliminated. For example, as discussed below, the membrane 70 can be bent, folded and/or rolled up as desired to facilitate the removal or addition of large components to the interior 52 of the nacelle 16.

The interior 52 of a nacelle 16 according to the present disclosure may be substantially or fully enclosed, as shown. For example, the flexible membrane 70, the frame 50, and the base platform 40 may each at least partially define the interior 52. The flexible membrane 70, the frame 50, and the base platform 40 may further be generally solid and/or non-permeable, and may surround the interior 52 so as to substantially enclose the interior 52. A substantially enclosed interior 52 may have openings defined for certain specific purposes, but may otherwise be fully enclosed. For example, the shaft 44 may extend through an opening defined in the flexible membrane 70 as shown to connect to the rotor 18. Further, an access passage may be defined in the flexible membrane 70. Further, other suitable openings for specifically defined purposes, such as ventilation, may be defined in the various components defining the interior 52. The interior 52 may be otherwise fully enclosed.

As mentioned above, a flexible membrane 70 according to the present disclosure may be formed from a suitable polymer material. In exemplary embodiments, for example, the polymer material may include polyurethane. Additionally or alternatively, the polymer material may include natural or synthetic rubber. In some embodiments, fibers may be embedded in the polymer material to reinforce the material. However, the materials utilized to form a membrane 70 according to the present disclosure must allow the membrane 70 to retain its flexibility, as discussed above.

In exemplary embodiments, the flexible membrane 70 includes a plurality of membrane sections 72. One or more of the membrane sections 72 may be connected to the frame 50, such as to one or more beams 54 thereof. Connection of the membrane 70 and membrane sections 72 to the frame 50 and beams 54 is discussed below. Additionally, membrane sections 72 may be connected to each other to form the flexible membrane 70. Still further, the membrane 70 or sections 72 thereof may in some embodiments be connected to the base platform 40.

As discussed, the flexible membrane 70 or sections 72 thereof is connected to the frame 50, such as to the beams 54. The connection may, for example, be by one or more connection features 74. A connection feature 74 according to the present disclosure may be, for example, a mechanical fastener such as a nut-bolt combination, rivet, screw, nail, etc., as shown in FIG. 2 Alternatively, a connection feature 74 may be for example a zipper as shown in FIG. 3 or a snap button, hook-and-loop fastener, another suitable male-female combination fastener, or any other suitable fastener. In many embodiments, one portion of the connection feature 74 may be disposed on the flexible membrane 70 or section 72 thereof, while a mating portion of the connection feature 74 may be disposed on a beam 54, another section 72, or the base platform 40. For example, a male portion of a fastener or a first portion of a zipper may be disposed on the flexible membrane 70 or section 72 thereof, while a female portion of a fastener or a second portion of a zipper may be disposed on a beam 54, another section 72, or the base platform 40, or vice-versa. The mating portions of a suitable zipper or fastener may be connected together, or a mechanical fastener may be utilized, to connect the flexible membrane 70 or section 72 thereof to a beam 54, another section 72, or the base platform 40.

FIG. 3 illustrates an exemplary embodiment of a membrane 70 connected to a beam 54. In this embodiment, a zipper is utilized to connect the membrane 70 and beam 54. One portion of the zipper is disposed on the membrane 70 while a mating portion is disposed on the beam 54. The zipper portions mesh with each other to connect the membrane 70 and beam 54 together.

In exemplary embodiments, the connection by one or more of the plurality of connection features 74 is generally watertight. A generally watertight connection feature 74 may be waterproof or water resistant, and may thus generally provide a moisture barrier between the interior 52 of the nacelle 16 and the exterior environment. For example, watertight zippers may in some embodiments be utilized to connect the membrane 70 or sections 72 thereof to a beam 54, another section 72, or the base platform 40.

One or more connection features 74 may in exemplary embodiments be disconnectable. This may allow the membrane 70 or sections 72 thereof to be quickly and easily disconnected from a beam 54, another section 72, or the base platform 40 as desired or required. For example, in many instances a component disposed in the interior 52 of the nacelle 16 may require repair or replacement. One or more of the connection features 74 can be disconnected, and the flexible membrane 70 bend, folded or rolled, to allow access to the interior of the nacelle 52 from outside of the nacelle 52. The number of connection features 74 that are disconnected, and the amount of the flexible membrane 70 that is manipulated, may be determined based on the size and shape of the component to be repaired or replaced. Thus, efficient and cost-effective repair or replacement of the internal components is facilitated.

It should be noted that disconnectable connection features 74 according to the present disclosure may further be reconnectable after access to the nacelle 16, such as for repair or replacement purposes, is no longer necessary.

As shown in FIG. 4, in some exemplary embodiments, one or more access passages 80 may be defined in the flexible membrane 70, such as in one or more sections 72 thereof. The access passage 80 may be an opening defined in the membrane 70 to provide access to the interior 52 of the nacelle. Such access passage 80 may have any suitable size and shape. In exemplary embodiments, an access passage 80 is sized and shaped for frequent access to the interior 52 by, for example, a maintenance worker.

Further, a passage cover portion 82 of the flexible membrane 70 may removable cover the access passage 80. The passage cover portion 82 may be the portion of the flexible membrane 70 that is cut or otherwise altered or removed to create the access passage 80. The passage cover portion 82 may generally cover the access passage 80, and be connected thereto by, for example, zippers or other suitable connection features. When access through the access passage 80 to the interior 52 is required, the passage cover portion 82 may bend, fold, or roll up to provide such access. The passage cover portion 82 may then be reconnected to the access passage 80 after access is no longer required.

In some further embodiments, further access openings (not shown) may be defined in the flexible membrane 70 for various other purposes. For example, access openings may be define in the membrane for ventilation purposes. Cover portions of the flexible membrane may removably cover these access openings, as discussed above.

Retention features (not shown) may additionally be provided on a nacelle 16 according to the present disclosure to retain the flexible membrane 70 or portion thereof when it is in a bent, folded, or rolled up position. For example, the flexible membrane 70 may be bent, folded, or rolled up for access to the interior 52 of the nacelle 16. The retention features may be connected to this portion of the flexible membrane 70 to retain it in this position. The retention features may then be disconnected to return this portion of the flexible membrane to its original position. The retention features may be straps, buckles, snaps, male-female fasteners, or any other suitable retention apparatus.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A nacelle for a wind turbine, comprising:
a base platform;
a frame, the frame comprising a plurality of beams and defining an interior; and,
a flexible membrane connected to the frame and further defining the interior, the flexible membrane comprising a polymer material,
whereby the interior is substantially enclosed.

2. The nacelle of claim 1, wherein the polymer material is polyurethane.

3. The nacelle of claim 1, wherein each of the plurality of beams is an I-beam.

4. The nacelle of claim 1, wherein the flexible membrane is connected to the frame by a plurality of connection features.

5. The nacelle of claim 4, wherein the connection at each of the plurality of connection features is generally watertight.

6. The nacelle of claim 4, wherein each of the plurality of connection features is a zipper.

7. The nacelle of claim 1, wherein an access passage is defined in the flexible membrane, and wherein a passage cover portion of the flexible membrane removably covers the access passage.

8. The nacelle of claim 1, wherein the flexible membrane is further connected to the base platform.

9. The nacelle of claim 1, wherein at least one of the plurality of beams is joined to the base platform.

10. The nacelle of claim 1, wherein the flexible membrane comprises a plurality of membrane sections, each of the plurality of membrane sections connected to one of the plurality of beams.

11. A wind turbine, comprising:
a tower; and,
a nacelle mounted on the tower, the nacelle comprising:
a base platform;
a frame, the frame comprising a plurality of beams and defining an interior; and,
a flexible membrane connected to the frame and further defining the interior, the flexible membrane comprising a polymer material,
whereby the interior is substantially enclosed.

12. The wind turbine of claim 11, wherein the polymer material is polyurethane.

13. The wind turbine of claim 11, wherein each of the plurality of beams is an I-beam.

14. The wind turbine of claim 11, wherein the flexible membrane is connected to the frame by a plurality of connection features.

15. The wind turbine of claim 14, wherein the connection at each of the plurality of connection features is generally watertight.

16. The wind turbine of claim 14, wherein each of the plurality of connection features is a zipper.

17. The wind turbine of claim 11, wherein an access passage is defined in the flexible membrane, and wherein a passage cover portion of the flexible membrane removably covers the access passage.

18. The wind turbine of claim 11, wherein the flexible membrane is further connected to the base platform.

19. The wind turbine of claim 11, wherein at least one of the plurality of beams is joined to the base platform.

20. The wind turbine of claim 11, wherein the flexible membrane comprises a plurality of membrane sections, each of the plurality of membrane sections connected to one of the plurality of beams.
